(19) United States
(12) Patent Application Publication
(10) Pub. No.: US 2012/0000777 A1
(43) Pub. Date: Jan. 5, 2012

(54) DEVICES AND METHODS FOR FORMING DOUBLE EMULSION DROPLET COMPOSITIONS AND POLYMER PARTICLES

(75) Inventors: Robin L. Garrell, Los Angeles, CA (US); Alexander K. Tucker-Schwartz, Los Angeles, CA (US); Heather Shepherd, Oakland, CA (US); Debalina Chatterjee, Hollywood, CA (US)

(73) Assignee: THE REGENTS OF THE UNIVERSITY OF CALIFORNIA, Oakland, CA (US)

(21) Appl. No.: 13/154,248

(22) Filed: Jun. 6, 2011

Related U.S. Application Data
(60) Provisional application No. 61/351,410, filed on Jun. 4, 2010.

(51) Int. Cl. C25B 15/00; B01F 3/08

(52) U.S. Cl. 204/451; 204/601

(57) ABSTRACT

The present invention generally relates to double emulsion droplet compositions, polymer particles that can be formed from such double emulsion droplet compositions, and to methods and apparatuses for making such compositions and particles. A double emulsion generally describes larger droplets that contain smaller droplets therein. These double emulsion droplet compositions can be used to create a variety of materials including polymer particles and polymeric shells and are further useful for encapsulating a variety of species including catalyst compounds and pharmaceutical agents. The double emulsion droplet compositions disclosed herein are readily formed using planar droplet (“digital”) microfluidic devices without channels, and either air or an immiscible liquid as an ambient medium.

### CROSS REFERENCE TO RELATED APPLICATIONS

This application claims priority under Section 119(e) from U.S. Provisional Application Ser. 61/351,410, filed Jun. 4, 2010, the contents of which are incorporated herein by reference.

### STATEMENT OF GOVERNMENT SUPPORT

This invention was made with Government support under Grant Nos. RR020070 and RR020070, awarded by the National Institutes of Health and Grant Nos. DGE 0114443 and DGE 0654431, awarded by the National Science Foundation. The Government has certain rights in this invention.

### BACKGROUND OF THE INVENTION

1. Field of the Invention

The present invention relates to the fields of microfluidics, especially droplet-based microfluidics or digital microfluidics (DMF).

2. Background

Emulsions refer to fluidic states which exist when a first fluid is dispersed in a second fluid that is typically immiscible or substantially immiscible with the first fluid. Examples of common emulsions are oil in water and water in oil emulsions. Emulsions consisting of a droplet inside another droplet (also known as a double emulsion droplets) are commonly made using a two-stage emulsification technique, such as by applying mechanical shear forces through mixing to reduce the size of droplets formed during the emulsification process. For example, polymer spheres, spheroids and shells are commonly made in bulk reactors by emulsion polymerization. In such methods, the reaction mixture contains one or more monomers, a dispersing solvent, and additional agents that may include catalysts or initiators, salts and surfactants (detergents, emulsifying agents). The monomer can be incorporated or dispersed into droplets by a variety of methods, most commonly by mechanical agitation (shaking, stirring) or sonication. The particle size distribution can range from fairly monodisperse (uniform size) to very polydisperse (heterogeneous). Generally, methods to make larger particles (diameters >˜50 μm) yield a wider distribution of particle sizes.

Microfluidic techniques have been used to mechanically insert a droplet inside of another droplet using multistep procedures. Methods based on fluidics technology have been developed to generate continuous streams of droplets including co-flowing streams, cross-flowing streams, and flow-focusing devices. In co-flowing stream methods, two tubes or needles of different diameters are inserted into one another. Immiscible liquids are then pumped through the two tubes. By controlling the relative rates of flow, the liquid emerging from the inner tube can be made to break up into droplets that are carried by the continuous stream of the outer liquid. That stream of droplets can subsequently be delivered into the stream of a third liquid, which strips each droplet and some of its surrounding liquid away from the tip of the tube or nozzle, mechanically forming a dispersed droplet-in-a-droplet. The dispersed ordinary or double emulsion droplets can then be polymerized to from polymer disks, spheres, and shells in the sub-micron-to-millimeter diameter size range. The same multiphase flow techniques can be implemented in channel-based microfluidic devices, which incorporate channels that can be sub-micron, micron, or millimeters wide and from micron to many centimeters in length, fabricated in planar substrates, typically enclosed by a top plate, and sometimes consisting of several connected or stacked plates.

Illustrative descriptions of techniques and apparatuses used to produce droplets inside of droplets include, for example, International Patent Application WO 2004/091763; or International Patent Application WO 2004/002627, each of which is incorporated herein by reference. See also Anna, et al., Appl. Phys. Lett., 82:364 (2003) and Okushima, et al., Langmuir 20:9905-9908 (2004). In some of these examples, a T-shaped junction in a microfluidic device is used to first form an aqueous droplet in an oil phase, which is then carried downstream to another T-junction where the aqueous droplet contained in the oil phase is introduced into another aqueous phase. In another technique, co-axial jets can be used to produce coated droplets, but these coated droplets must be re-emulsified into the continuous phase in order to form a multiple emulsion. See Loscertales et al., Science 295:1695 (2002). Formation of polymer particles by all of the above-described methods requires the monomer-containing emulsion droplet to be surrounded by another liquid: the dispersing liquid in the case of bulk emulsion or suspension polymerization, or the stripping liquid for tube- and channel-based droplet fluidic systems.

Double emulsion droplets and the products that can be made from them (e.g. polymer particles) can be adapted for use in a variety of industrial, research and pharmaceutical contexts. Consequently improved methods and devices for producing double emulsion droplets and polymer particles are highly desirable.

### SUMMARY OF THE INVENTION

The invention disclosed herein provides methods for making double emulsion droplet compositions and polymer particles using microfluidic devices without conventional fluid channels, and either air or an immiscible liquid as the ambient medium. The method utilizes a droplet manipulation technique known as digital microfluidics. In digital microfluidics, droplets are moved over an array of electrodes by means of ElectroWetting-On-Dielectric (EWOD), dielectrophoresis and/or other mechanisms. In EWOD, the apparent local wettability of a surface is reversibly changed by applying potentials between electrodes buried beneath hydrophobic, dielectric layers (see, e.g. Chatterjee et al., Lab Chip, 2009, 9, 1219-1229). As disclosed herein, in droplet (“digital”) microfluidic devices, liquid droplets in contact with dielectric surfaces are created, moved, merged and mixed by applying electrical potentials (AC or DC) across electrodes patterned beneath the dielectric. Liquids with a wide range of polarities can be actuated electromechanically on such devices. The electromechanical force has both electrowetting (EW) and dielectrophoretic (DEP) contributions. As discussed below, the spontaneous insertion/engulfment characteristic of these methods has a number of advantages over conventional methods for making double emulsion droplets.

A method in accordance with the present invention comprises forming double emulsion droplets and/or polymer particles using at least one droplet-based microfluidic device capable of manipulating droplets of different liquids (e.g. a first liquid comprising monomer molecules and a second liquid comprising initiator molecules), by delivering or placing the droplets at specified locations on an electrode array; and moving the droplets within the array order to bring them together in a manner that allows one droplet to spontaneously insert into the other, thereby forming an emulsion droplet. Those of skill in this art understand that this encompasses, for example, situations where a moved droplet will surround/engulf a stationary one. In certain illustrative embodiments of the invention, one can generate the droplets of the invention by dispensing fluids from one or more reservoirs, dividing/splitting an existing droplet, and/or inserting or depositing the liquid droplet from an external source (e.g. via a pipette or through an inlet or the like). One can, for example, combine two miscible droplets, for example to make a solid particle. This can be done in air, with no outer droplet. Alternatively, one can take one droplet inside an immiscible droplet, and further bring in a third droplet that will insert and merge with the inner droplet. In such embodiments, one can then, for example, gel or polymerize the inner droplet. In yet another embodiment, a droplet in a droplet can further be manipulated to bring another droplet that merges with the outer liquid and induces polymerization, so as to form shell.

The methods of the invention typically include the use of droplet-based microfluidic devices formed in an array geometry, by applying a sequence of electrical signals to enable transport of droplets across the droplet-based microfluidic device surface, the sequence of electrical signals being applied to a pattern of electrodes buried beneath a dielectric layer on the droplet-based microfluidic device surface. Embodiments of the method can comprise additional methodological steps that, for example, facilitate polymerization reactions (e.g. exposing an emulsion droplet formed in the microfluidic device to UV light to form a polymer particle or merging with other droplets containing agents that might induce reversible or irreversible gelation or polymerization. In certain illustrative embodiments of the invention, one can use a gelling agent (e.g. calcium ions) to induce gelation of a material (e.g. alginate).

Several configurations of digital microfluidics-based devices can be used in the methods of the present invention, including single-plate single plate (open air) devices, parallel-plate devices filled with a water immiscible liquid (e.g. silicone oil), and parallel-plate open-air devices that may or may not be sealed. Device embodiments of the invention can, for example, be sealed in order to maintain humidity and/or slow evaporation in the device. Embodiments of the invention include using such devices in processes for synthesizing uniform polymer particles as well as a wide variety of other double emulsion droplet compositions that are useful in a large number of contexts including the energy, paint, food and pharmaceutical industries. Those of skill in this art understand that the particles can be uniform in size and shape, but not necessarily solid. Consequently, embodiments of the invention can make particles of prescribed sizes, and also several different shapes that can be solid or shells. Embodiments of the invention can use dielectrophoresis-based droplet centering technology to make polymer shells in which the outer and inner surfaces are highly concentric. One application for such shells is for use in cryogenic fuel targets for inertial confinement fusion energy production. These cryogenic targets are used in inertial confinement fusion (ICF) technology, a promising new method for clean commercial energy production.

An illustrative embodiment of a device that can be used in accordance with the methods of the present invention comprises a first plate comprising an array of first electrodes, a second plate, comprising at least a second electrode, wherein the first plate and the second plate are spaced apart such that a droplet can travel between the first plate and the second plate, a first layer of one or more materials, covering the array of first electrodes, and a second layer of one or more materials, covering at least the second electrode, wherein application of electrical signals between selective electrodes within the array of first electrodes and the at least one second electrode moves the droplet between the top plate and the bottom plate. In addition, other device embodiments that can be used in accordance with the methods of the present invention include devices with a single plate with an array of electrodes. In this configuration, droplets are manipulated on the array by applying potentials between electrodes on a single plane, with no need for a top plate. The layers of material used to coat the devices typically include dielectric coating materials such as a polysilicon and/or hydrophobic coating materials such as a polydimethylsiloxane composition or a polytetrafluoroethylene composition (e.g. TEFLON-AF) that may be physically coated or chemically bonded to the underlying dielectric material. Alternatively, the dielectric layer may be rendered more hydrophilic by various treatments (e.g. oxygen plasma), by applying a hydrophilic coating such as poly(ethylene glycol), or by chemically grafting small molecules or polymers onto the dielectric layer to increase the hydrophilicity of the surface.

Other objects, features and advantages of the present invention will become apparent to those skilled in the art from the following detailed description. It is to be understood, however, that the detailed description and specific examples, while indicating some embodiments of the present invention are given by way of illustration and not limitation. Many changes and modifications within the scope of the present invention may be made without departing from the spirit thereof, and the invention includes all such modifications.

### BRIEF DESCRIPTION OF THE FIGURES

FIGS. 1A-1D provide illustrations of typical droplet (“digital”) microfluidic devices. FIGS. 1A-1C show schematic illustrations. FIG. 1D, shows a photograph of an actual device (for which only the bottom plate is shown).

FIGS. 2A-2B show photographs of two examples illustrating the actuation and spontaneous insertion of a water droplet into a droplet of an immiscible liquid in a two-plate digital microfluidic device. FIG. 2A shows 0.5 μL water droplet inserting into 0.5 μL decane. FIG. 2B shows 0.5 μL water inserting into 0.5 μL ,α,α-trifluorotoluene. The gap between the top and bottom plates was 300 μm, and each electrode was 1 mm×1 mm. Note that when the water and immiscible liquid droplet come into contact, the “oil” phase immediately surrounds the water at a rate faster than our 30 fps camera could record. From the video images, we estimate the insertion occurs in ≦0.1 s. We have also successfully inserted water into hexadecane, cyclohexane, toluene, ethyl acetate, heavy mineral oil, and 50 cSt silicone oil. The inner droplet can be less polar than the outer droplet. In one illustrative embodiment, we have shown that methanol and isopropanol spontaneously engulf heavy mineral oil. FIG. 2C shows 0.5 μL droplet of isopropanol (IPA) is moved into contact with a 0.5 μL heavy mineral oil (Oil) droplet on a two-plate TEFLON-AF coated droplet-based microfluidic device. Upon contact, the IPA immediately engulfs the oil at a rate faster than our 30 fps camera could record. Each electrode is 1 mm×1 mm. FIG. 2D shows illustrative models systems and typical devices of the invention. FIG. 2E shows illustrative shapes that droplets can take in embodiments of the invention. FIG. 2F shows an illustrative fabrication schematic for an embodiment of the invention. FIG. 2G shows an illustrative formation of a double emulsion droplet and subsequent polymerization to form a polymer particle of the invention.

FIGS. 3A-3B provide images showing oblique and side views of a water droplet (containing dye, in the three left-most sets of images in 3A, to enhance contrast) in toluene between TEFLON-AF—coated glass slides. Note that the inserted droplet is fully encapsulated and not in contact with the top or bottom plates, irrespective of its volume. As shown in FIG. 3B, the larger water droplet assumes a discoid shape. When the inserted water droplet is small enough, it assumes a shape with the minimum surface area, a sphere. The schematic shown in FIG. 3B illustrates idealized shapes of the liquid volumes.

FIG. 4 provides images showing the actuation and spontaneous insertion of a 0.5 μL droplet of tripropyleneglycol diacrylate (TPGD, a monomer) with 4% w/w 1-hydroxycyclohexyl phenyl ketone (HPK), a photoinitiator, into a 0.5 μL droplet of an immiscible solvent (hexadecane). Irradiation with a 4 W UV lamp (λₘₐₓ=365 nm) induces polymerization of the inner droplet, forming a solid polymer particle. After a 10 min rest period, the solidified particle was removed. (In the images, “or”=hexadecane.) The electrodes were 1 mm square and the gap between plates was 300 μm.

FIG. 5 provides photographs of polymer particles formed using embodiments of the invention: As shown in FIG. 4, TPGD droplets containing a photoinitiator spontaneously insert into droplets of hexadecane and can be polymerized by a handheld 4 W UV lamp to form polymer particles. TPGD can also be inserted and polymerized in hexadecane by pressing the droplets between two TEFLON-AF coated plates, and irradiating with UV light. TPGD particles polymerized using 0.5 μL volumes and a 300 μm gap are on average, ˜1.5 mm in diameter and ˜280 μm in height, solid, translucent, and tough. An example is shown in the two images at left. The oblong shape is a consequence of deformation of the TPGD droplet as it inserts into the hexadecane. The deformation persists because of the low liquid/liquid interfacial tension. Images of a particle formed by pressing droplets between two plates are shown on the right.

FIGS. 6A-6B illustrate typical digital microfluidics devices that can be used with methods of the present invention;

FIG. 7 provides an illustration of exemplary generalized computer system 202 that can be used to implement elements of the present invention.

### DETAILED DESCRIPTION OF THE EMBODIMENTS

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art. As appropriate, procedures involving the use of commercially available kits and reagents are generally carried out in accordance with manufacturer defined protocols and/or parameters unless otherwise noted. A number of terms are defined below. All publications mentioned herein are incorporated herein by reference to disclose and describe the methods and/or materials in connection with which the publications are cited. Publications cited herein are cited for their disclosure prior to the filing date of the present application. Nothing here is to be construed as an admission that the inventors are not entitled to antedate the publications by virtue of an earlier priority date or prior date of invention. Further the actual publication dates may be different from those shown and require independent verification.

It must be noted that as used herein and in the appended claims, the singular forms “a”, “and”, and “the” include plural referents unless the context clearly dictates otherwise. Thus, for example, reference to “a droplet” includes a plurality of droplets and equivalents thereof known to those skilled in the art, and so forth. All numbers recited in the specification and associated claims that refer to values that can be numerically characterized with a value other than a whole number (e.g. the diameter of a droplet) are understood to be modified by the term “about”.

The present invention generally relates to double emulsion droplets and polymer particles that can be formed using these droplets, and to methods and apparatuses for making such double emulsion droplets and polymer particles. A double emulsion droplet, as used herein, describes larger droplets that contain smaller droplets therein. Double emulsion droplets can be used to form polymer particles as well as to encapsulate species such as pharmaceutical agents and other chemical compounds, or the like. In some embodiments, one or more of the droplets (e.g., an inner droplet and/or an outer droplet) can change form (e.g. via a polymerization reaction), for instance, to become solidified to form a variety of structures such as a microcapsule, a liposome, a polymerosome, a colloidosome or the like.

The present invention relies on droplet-based microfluidics (also known as “digital microfluidics”) to create, dispense, transport, merge, mix, cut, and deliver droplets containing samples and reagents to specified locations on an electrode array. Briefly, in droplet-based microfluidics, a sequence of potentials is applied to adjacent electrodes buried beneath dielectric layers. When a potential is applied across electrodes in the device, two phenomena may be observed: (1) a droplet may move towards the biased electrode, and (2) the contact angle between the droplet and device surface may decrease because of a change in the local wettability of the surface. A change in surface wettability is not required for droplet movement. The present invention is the first to use droplet-based microfluidics for on-chip sample preparation of double emulsion droplets and polymer particles.

The present invention makes use of technology for manipulating droplets of homogeneous liquids, as well as liquid droplets that contain suspended liquid droplets (emulsions) or suspended solids (suspensions), by droplet-based microfluidics, which is described in detail in the publications noted herein. A homogeneous liquid may be a pure liquid, or a liquid in which one or more components have been dissolved. Droplet manipulations may include any or all of the following functions: droplet generation or dispensing, movement, dividing or splitting, and merging (e.g. to form a double emulsion droplet). The droplets may consist of pure liquids, solvents, solutions, or suspensions. Soluble substances or suspended particles in the droplets may be reagents, polymers or other agents such as surfactants that modify the physical properties of the droplets, samples (analytes), labeling agents (molecular or particulate), reagents and/or catalysts.

Using the methods and devices described herein, a consistent size and/or number of droplets can be produced, and/or a consistent ratio of size and/or number of outer droplets to inner droplets (or other such ratios) can be produced. For example, in some cases, a single droplet within an outer droplet of predictable size can be used to provide a specific quantity of a reactant, catalyst, pharmaceutical compound or the like. In addition, combinations of compounds or drugs may be stored, transported, or delivered in a double emulsion droplet. For instance, hydrophobic and hydrophilic species can be delivered in a single, double emulsion droplet, as the droplet can include both hydrophilic and hydrophobic portions. The amount and concentration of each of these portions can be consistently controlled in embodiments of the invention, a characteristic of which can be used to provide for a predictable and consistent ratio of two or more species in the double emulsion droplet.

Fields in which double emulsion droplets and/or polymer particles are useful include, for example, polymer chemistry, food, beverage, health and beauty aids, paints and coatings, and drugs and drug delivery. For instance, a precise quantity of a compound or isotope (e.g. deuterium/tritium), pharmaceutical, or other agent can be encapsulated by a polymeric shell designed to rupture under particular (e.g. physiological) conditions. Other species that can be stored and/or delivered include, for example, biochemical species such as nucleic acids such as siRNA, RNAi and DNA, proteins, peptides, or enzymes. Additional species that can be incorporated within double emulsion droplets of the invention include, but are not limited to, eukaryotic cells, microorganisms, spores, nanoparticles, colloids, micelles, liposomes, fragrances, indicators, dyes, chemical reagents, catalysts, fluorescent species and the like. A double emulsion droplet and/or polymer particle can also serve as a reaction vessel in certain cases, such as for controlling chemical reactions.

### Illustrative Droplet Microfluidic Devices Useful with Embodiments of the Invention

As discussed in detail below, typical embodiments of the invention disclosed herein include the use of planar droplet (“digital”) microfluidic devices adapted to form double emulsion droplets without conventional fluid channels, and by using either air or an immiscible liquid as the ambient medium through which droplets are manipulated and/or formed. Illustrative embodiments of the invention include using processes for synthesizing uniform polymer particles via spontaneous insertion of one droplet into a second droplet in air.

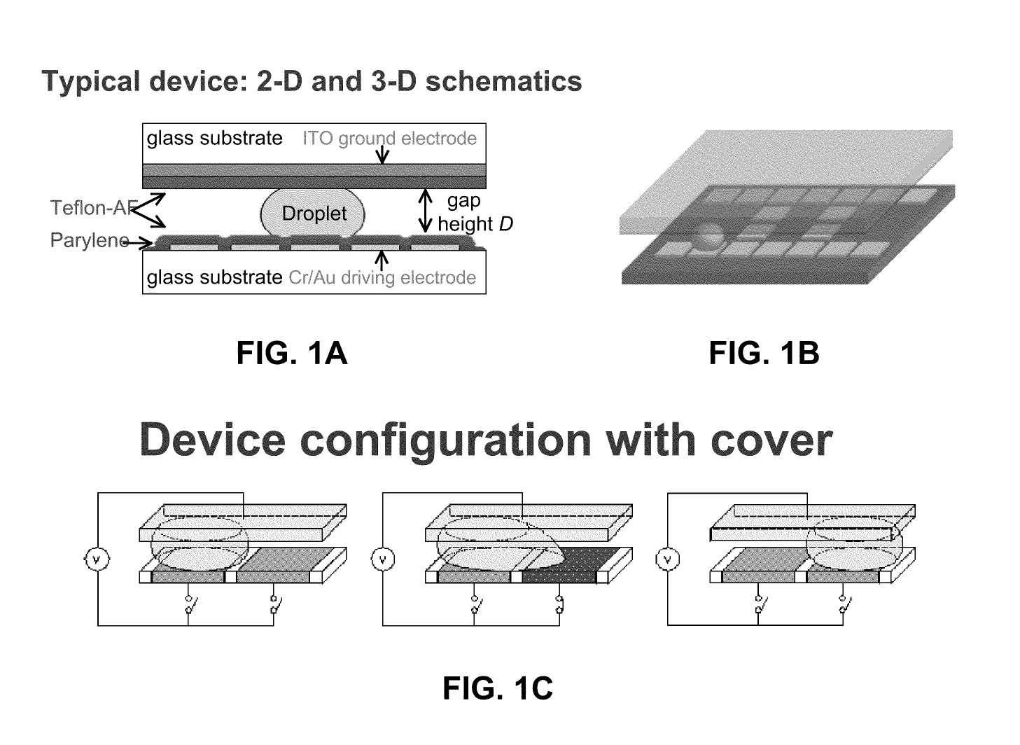

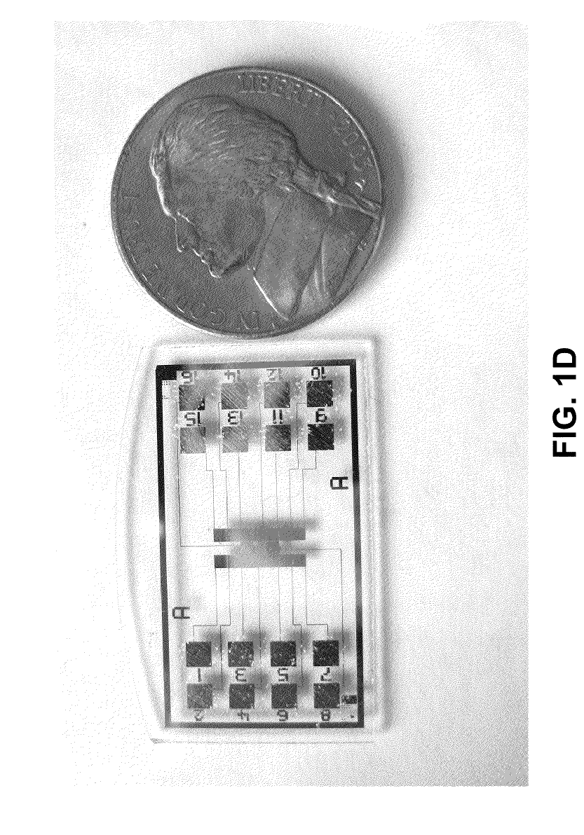

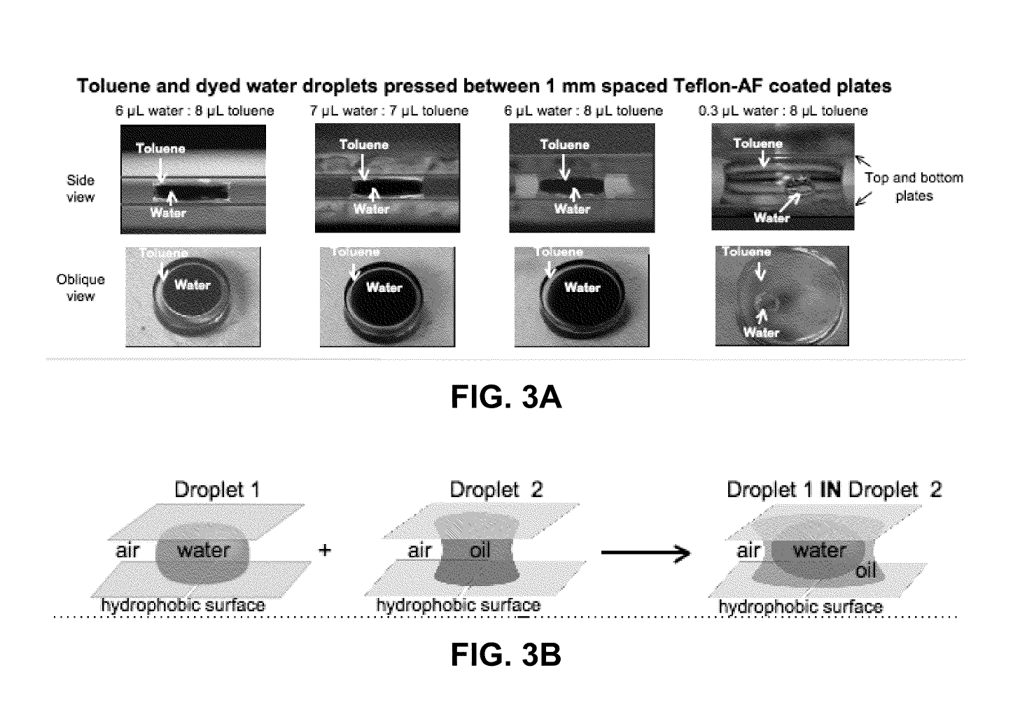

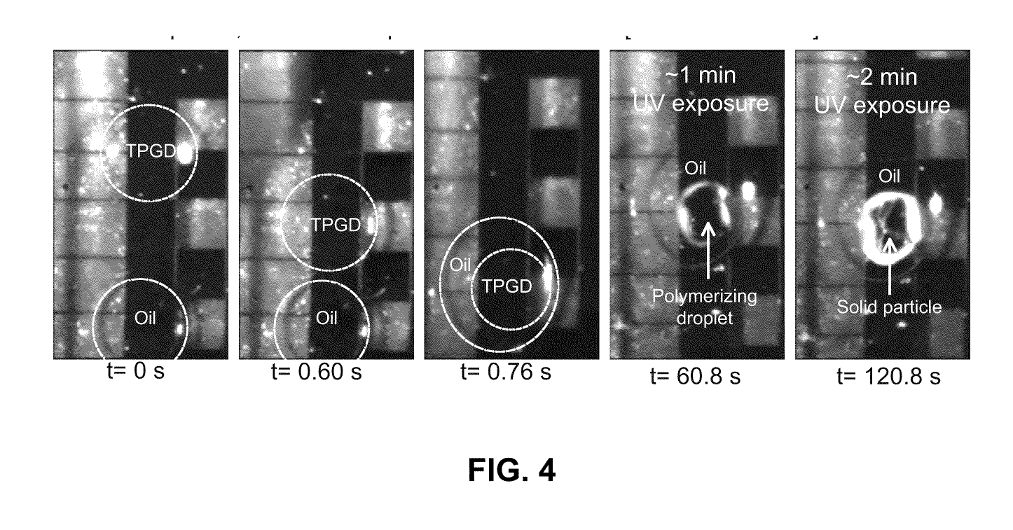

In some device systems useful with embodiments the invention, droplets, from sub-nanoliter up to several hundred microliters in volume, are dispensed or positioned between the two plates. In such embodiments, the droplets are moved between the two plates by sequentially applying an electrical potential across electrodes patterned beneath a dielectric layer on the bottom plate and a dielectric-coated continuous electrode on the top plate. In other embodiments of the invention, the device can consist of just a single, bottom plate and the electrical potential applied across pairs of electrodes in this bottom plate. In such single and double plate devices, the path and timing that the droplets follow can be controlled by a specific sequence of applied voltages (e.g. one programmed into a computer coupled device system, or applied manually). Illustrative embodiments of devices useful with embodiments of the invention are shown in FIGS. 1-4 and 6.

Embodiments of the devices disclosed herein include an arrangement of electrodes to create a potential which can be manipulated to dispense, transport, merge, mix, divide or split, and deliver droplets containing monomers, solvents, suspended particles and/or reagents to specified locations along the path of electrodes. In such situations, the applied electrical potential creates an electromechanical force that is manifested as dielectrophoresis (DEP) and electrowetting (EW). Significantly, both conductive and insulating (dielectric) liquids can be actuated on this type of device. Moreover, it is possible to perform droplet processes sequentially or parallel by addressing electrodes individually or in combination. The array nature of the device makes it possible to make more than one particle at a time. As shown herein, an appropriate ambient medium that can surround the droplets within the devices includes air. In other embodiments, a medium that surrounds the droplets can be an immiscible liquid.

In typical practice, droplets of two different liquids whose material properties and volumes are known, are dispensed on either a one-plate or two-plate digital microfluidic device. When the device is coated with an appropriate dielectric material, one droplet will spontaneously insert into the other, forming an emulsion droplet. A wide variety of materials can be made by these methods. For example, when one or both droplets contain a polymerizable monomer and associates polymerization agents, polymer particles of various geometries and topologies can be synthesized.

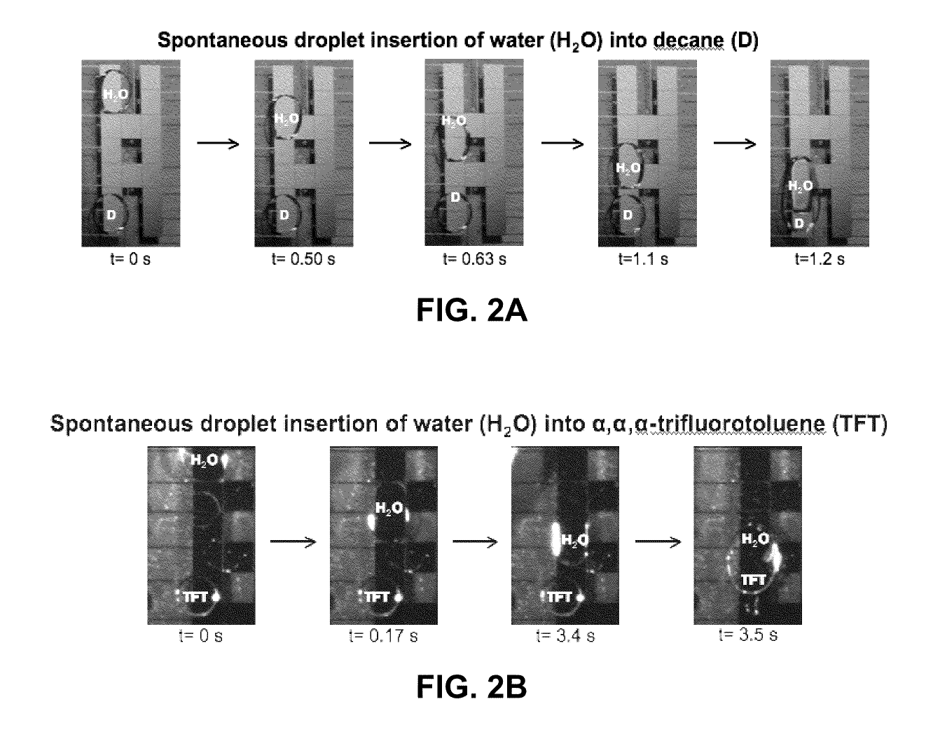

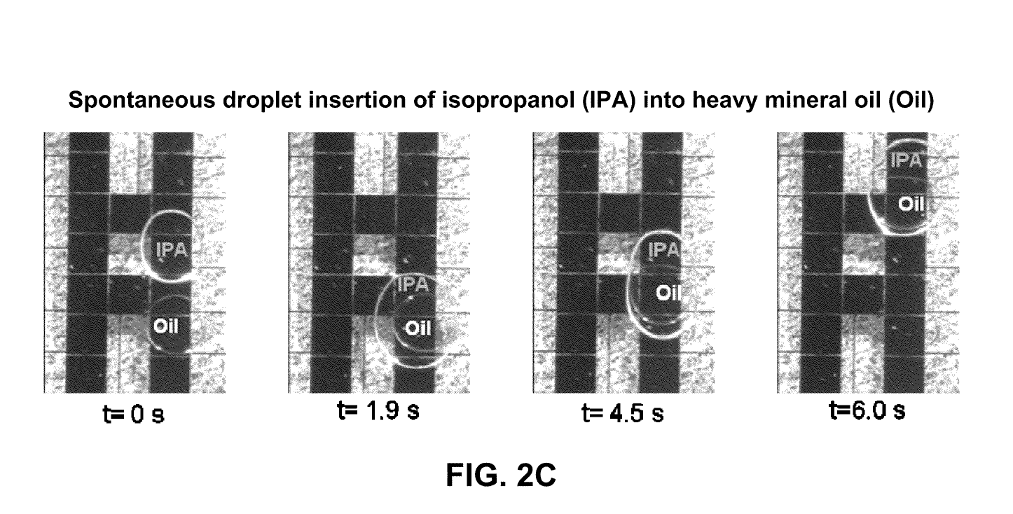

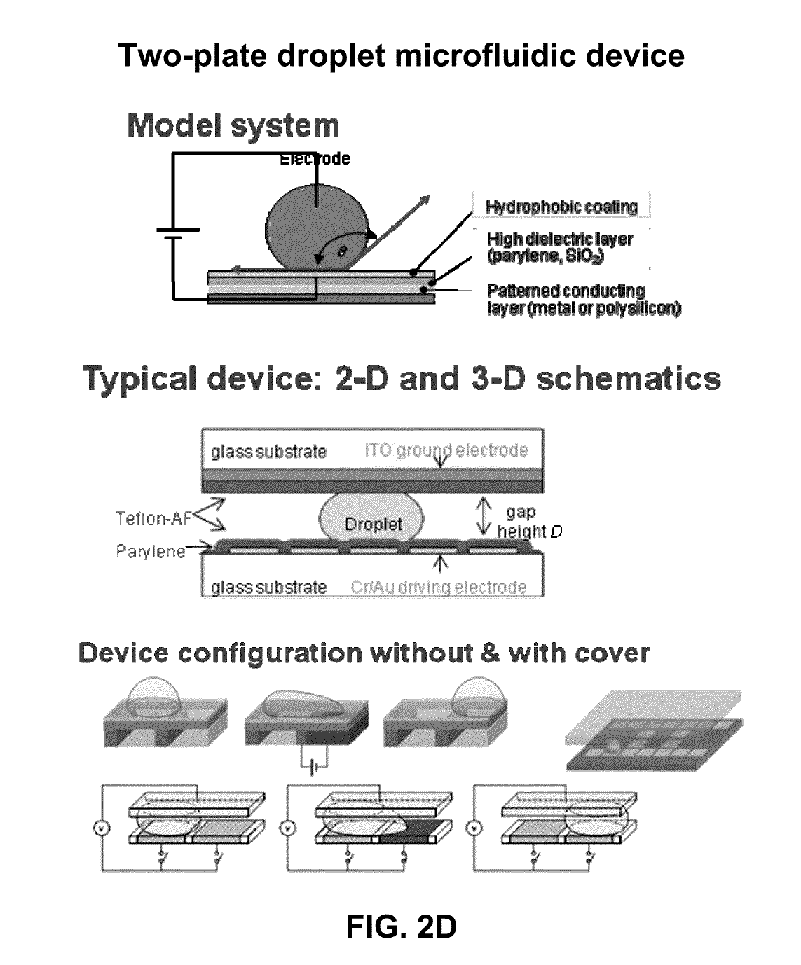

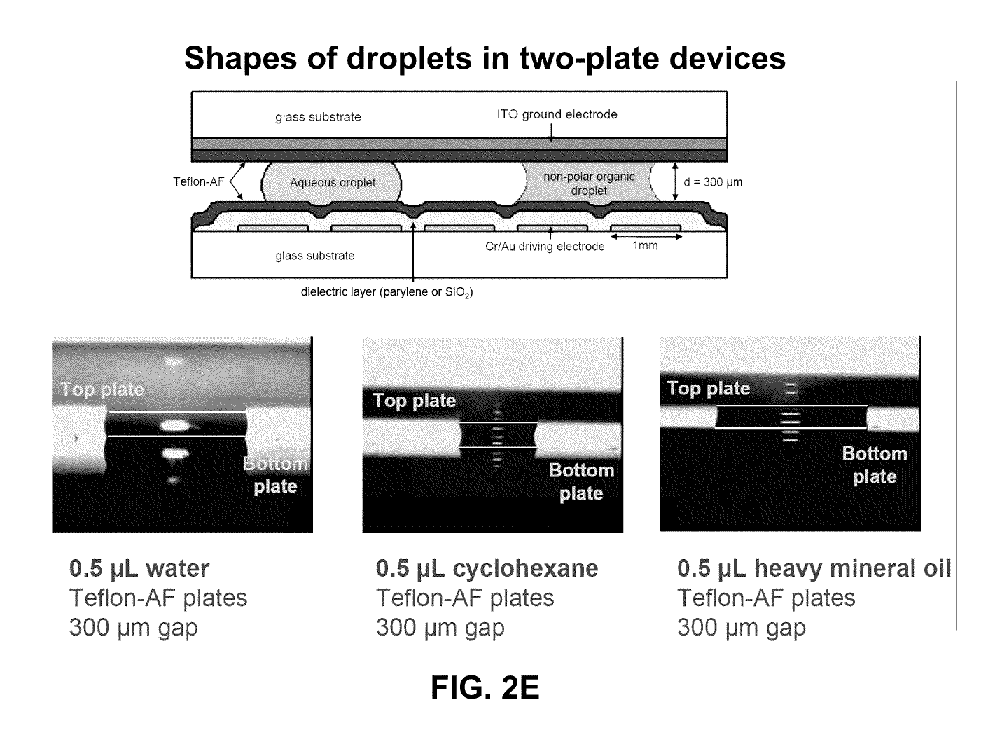

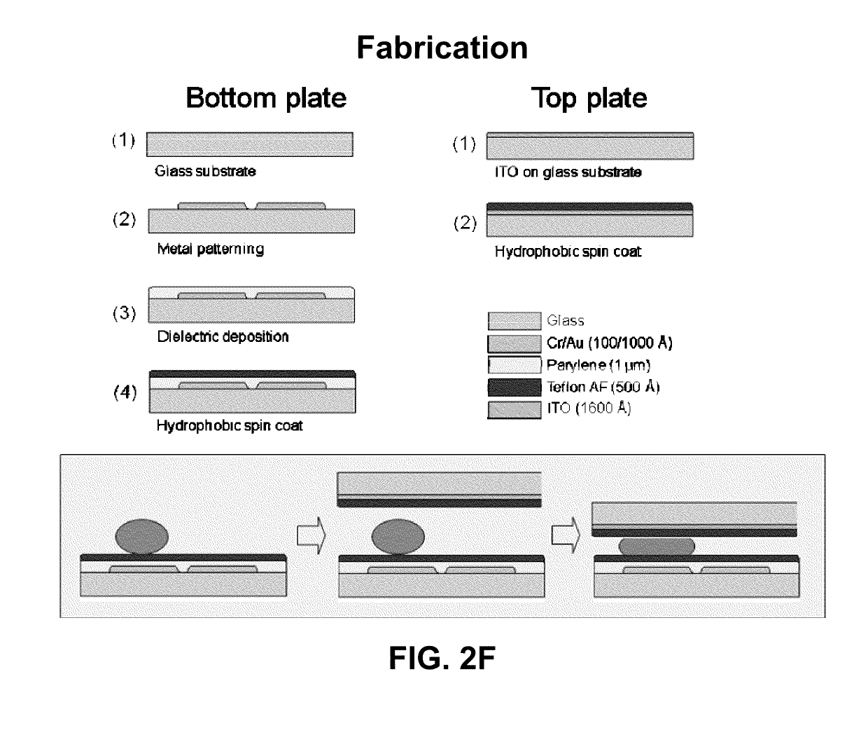

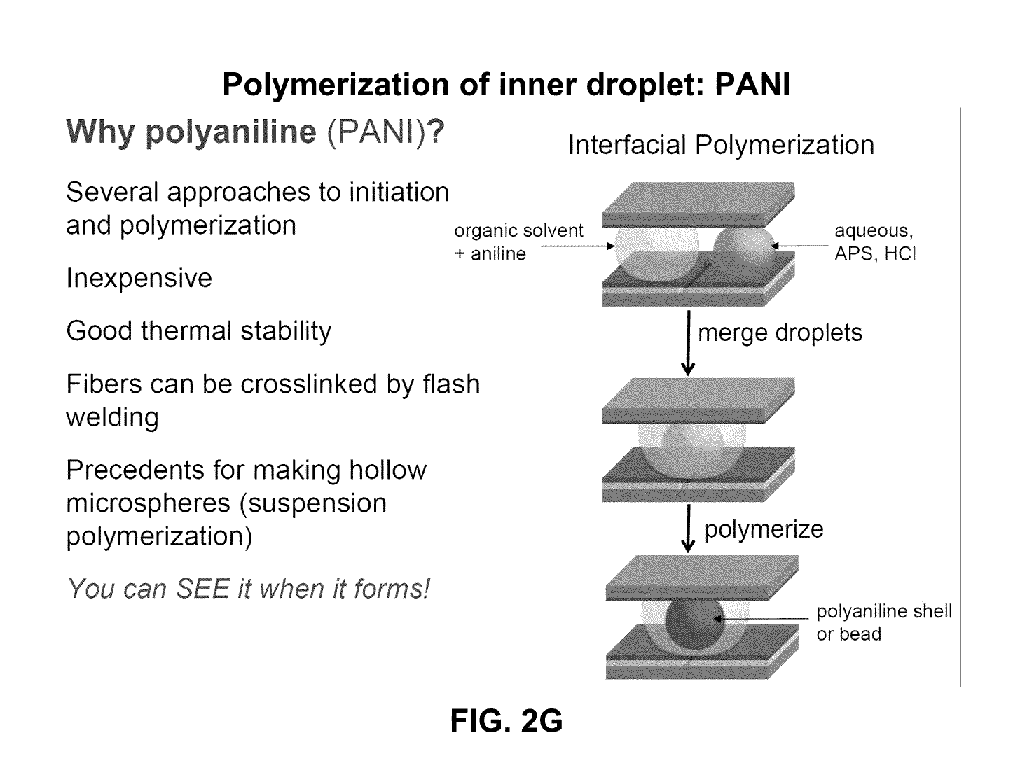

In some embodiments of the invention, the device surfaces over which the droplets move are coated with a hydrophobic material such as a polydimethylsiloxane composition or a fluorinated polymer composition (e.g. polytetrafluoroethylene). The low surface energy of this material allows a dispensed droplet of one liquid (L1) to spontaneously insert into a droplet of a second liquid (L2) in a third surrounding (ambient) medium. For example, when air is the ambient medium, an actuated water droplet spontaneously inserts into a stationary droplet of toluene or hexadecane (see, e.g. FIG. 2). In embodiments of the invention, one or both droplets may be moving when the spontaneous insertion occurs. L1 may be completely or only partially immiscible in L2. The surrounding medium may be the same as L1, a different liquid that is completely or partially immiscible with L2, or air. L1, L2 or the surrounding medium may each contain compounds selected to react with the droplet compositions, for example prepolymerized monomers, polymer initiators, or both, as well as other components. When one or several of the liquids contain such monomers and/or initiators, they can undergo polymerization reactions to form polymer disks, spheres, spheroids and shells. The compounds selected for use in L1, L2 or the medium can be controlled to produce a variety of compositions having a variety of architectures. For example, in methods designed to form polymeric materials, if more than one monomer is used and each monomer is segregated in different droplets, then core-shell polymer particles can be synthesized. Such polymerization reactions can proceed by a variety of mechanisms known in the art including radical, anionic, cationic, condensation, metathesis, atom transfer, living, or oxidation/reduction mechanisms. Heat, light, or chemical agents may be used to initiate such polymerization processes directly, or to activate an initiator that subsequently reacts with the monomer. Gelation or crosslinking processes induced by chemical agents, heat, or light may be used to partially or completely solidify the liquid droplets. The solidified material may be gel-like, foamy, fibrous, glassy, or polycrystalline. Solutes or particulate material present in the liquid droplet may, following gelation or polymerization, be uniformly or heterogeneously embedded in the solid, or may partially or completely reside at an interface. Thus the polymer particles may be pure polymers or copolymers, composites, hydrogels, or interpenetrating networks.

The devices disclosed herein include features that allow artisans to precisely control characteristics of the double emulsion droplets. For example, the shape and size of the polymer particles that can be formed can be controlled by the device gap height, the ambient medium, the compositions used to form the double emulsion droplets as well as the absolute and relative volumes of the droplets that are dispensed and actuated. For example, the selection of the compounds present in the droplet compositions can control both the spontaneous insertion event as well as the characteristics of the double emulsion droplet, for example by influencing the interfacial tensions or energies (solid-liquid, liquid-liquid, liquid-air), the miscibility and volatilities of the liquids, and other variables. The topology and porosity of the polymer particles can further be controlled by these and other factors, including the rate of polymerization, the presence of crosslinking agents (multi-functional monomers), and the relative amounts of compounds disposed within the droplets (e.g. the stoichiometry). Similarly, as fluid hydrophobicity/hydrophilicity and fluid viscosity can affect droplet formation, in some cases the hydrophobicity/hydrophilicity and/or viscosity of the inner and/or outer fluids may be adjusted by adding or removing components, such as diluents, that can aid in adjusting these fluid material properties. For example, in some embodiments, the viscosity of the inner fluid and the outer fluid are equal or substantially equal. In other embodiments, the outer fluid may exhibit a viscosity that is substantially different from the inner or outer fluid.

The devices useful in embodiments of the invention disclosed herein have a number of embodiments. A typical embodiment of the invention is a two-plate droplet microfluidic device having dielectric-coated surfaces, surfaces whose hydrophobicity is known and controllable. Droplets can be dispensed onto the device by pipettes, or metered out in a deterministic fashion by on-chip dispensing reservoirs. Two different liquids, L1 and L2, that are completely or partially immiscible in one another, are dispensed into reservoirs on the device. Either liquid may contain soluble or particulate components. The surrounding (ambient) medium can be a third liquid (L3) or air, and L3 may have components similar or identical to L1. In methodologies designed to make polymer particles, one or both dispensed liquid droplets can contain some combination monomers and/or initiators, as well as other components. Applied voltages are then applied to the electrodes in the device in order to generate electromechanical forces (electrowetting and dielectrophoresis) that initiate and sustain the controlled movement of a droplet of L1. This droplet is positioned within the device so that it comes into contact with a droplet of L2. As soon as the droplets come into contact, the L1 droplet spontaneously inserts into the L2 droplet. At this point, polymerization can be initiated to form: a solid particle if monomer is present and polymerization takes place in the L1 droplet, a shell, if monomer is present and polymerization takes place in L2, or a core-shell particle, if both droplets contain monomer(s). In a core-shell particle, polymerization may take place in the inner and outer droplets simultaneously or sequentially. If only one liquid contains monomer, the emulsion droplet may be polymerized to form a polymer disk, sphere, spheroid or shell, depending on the liquid volumes and device geometry. Core-shell particles may be solid spheres, spheroids, or discoids. Core-shell particles may be hollow rather than solid, and be spherical, spheroid, discoid or toroid in shape, with the interior consisting of air, a pure liquid, a liquid solution containing soluble components, a liquid suspension containing solid particles or a polymerized material.

As noted above, embodiments of the present invention include microfluidic systems which have unfixed virtual channels (see, e.g. PCT publication WO 2007/136386 and U.S. Patent Application Nos. 20110056834 (e.g. FIG. 1 and FIG. 2) and 20090250348, the contents of which are incorporated by reference). In particular, in these microfluidic systems the channels are virtual channels formed by the plurality of electrodes, thereby overcoming certain limitations of conventional channels (e.g. limitations directions in which a fluid can flow). As users apply a voltage to different electrodes, the fluid can flow to different locations, thereby providing programmable fluid manipulation. In typical embodiments, the microfluidic system includes: a first electrode plate which has a substrate and an electrode layer disposed on one side surface of the first substrate; a second electrode plate which has a second substrate and a plurality of electrodes, wherein the electrodes are disposed on one side surface of the second substrate which is opposite to the electrode layer, and arranged in a microchannel pattern. This embodiment of the invention further includes spacing structure or gap which is disposed between the first electrode plate and the second electrode plate so that a space is formed between the first electrode plate and the second electrode plate. Optionally, the spacing structure or gap is formed using one or more spacers. Such spacers can be adjustable and formed from an insulating material. In certain embodiments of the invention, multiple spacers are arranged to form a continuous frame structure.

In illustrative embodiments of the invention, the first electrode plate, typically inverted and deployed as the top plate of the device, includes a substrate and an electrode layer. The substrate can be a rectangular plate or wafer formed from a composition such as glass, quartz, a silicon composition, poly-dimethylsiloxane (PDMS), polyethylene terephthalate (PET), polyethylene naphthalate (PEN) or a flexible polymer material, etc. In illustrative embodiments, a single contiguous electrode layer is deposited on the surface of the substrate and covers the whole surface of the substrate. Optionally, multiple electrodes may be patterned as an alternative to a single contiguous electrode. Optionally the plate is coated with one or more dielectric layers, one of which may be hydrophobic or hydrophilic. The material of the electrode layer may be one or several conductive metal materials (e.g. Cr/Au), a conductive polymer material or a conductive oxide material (e.g. indium tin oxide, ITO) etc. Such electrode layers can be deposited on the first substrate via any of a number of well known processes such as E-beam evaporation, physical vapor deposition, sputtering etc. and removing unwanted materials via etching and so on to form the plurality of electrodes in a prescribed pattern. The electrodes may have any two-dimensional shape, and may be adjacent, interdigitated, etc. The dielectric layer is typically formed by depositing the material of the dielectric layer on the substrate and the electrodes. The dielectric layer(s) can comprise one or more dielectric materials commonly used in the art, such as polymers (e.g., parylene-C or parylene-N, positive photoresist, negative photoresist), inorganic materials (e.g. but not limited to barium strontium nitrate, silicon nitride, various silicon oxide compositions). The material may have high or low dielectric constant.

In some embodiments, a hydrophilic layer of material (e.g. poly(ethylene glycol) oligomers and polymers to make the surface more wettable) is disposed on the surface of the electrode layer and optionally covers some or all of the surface of the electrode layer or array, In some embodiments, a hydrophobic layer is deposited on the substrate and electrodes or on top of the dielectric layer, and covers some or all of the electrode array. The material of the hydrophobic layer may be a hydrophobic compound known to be useful in such contexts, such as a fluorinated polymer composition (e.g. materials such as but not limited to TEFLON-AF, CYTOP, Kiss-Cote® or the like). The hydrophobic layer is typically deposited on the electrode layer via any of a number of well know processes such as physical or/and chemical deposition or spin coating etc. The hydrophobic layer may cover the entire plate or may be patterned during or following its initial deposition via any number of well known methods such as masking, ablation, chemical or physical etching. The effect of the hydrophobic layer is that the contact angle of a liquid on such a surface may increase, which can facilitate electromechanical actuation of the liquid. This phenomenon is often described as hydrophobicity, although it can also be observed for nonaqueous liquids. The hydrophobic layer is not required for droplet movement.

In illustrative embodiments of the invention, the second (bottom) electrode plate includes a second substrate, one or a plurality of electrodes, a dielectric layer and an optional hydrophobic layer. The second substrate is similar to the first substrate discussed above and can be, for example, a rectangular plate formed from glass, quartz, a silicon composition, poly-dimethylsiloxane (PDMS), polyethylene terephthalate (PET), polyethylene naphthalate (PEN) or a flexible polymer material etc. In embodiments of the invention, the electrodes can be deposited on the top surface of the second substrate. The material of the electrodes may be one or several conductive metal materials (e.g. Cr/Au), a conductive polymer material or a conductive oxide material etc., indium tin oxide (ITO) etc. The shape and the arrangement of the electrodes can depend on a particular pattern that is desired. In illustrative embodiments of the invention, the pattern on the bottom plate can include a plurality of reservoirs and/or a plurality of droplet positioners where each of the reservoirs and the positioners comprises one or several electrodes. Those of skill in this art understand the different locations on which the elements in such devices can be placed and oriented on the plates in order to construct a variety of functional systems (see, e.g. the illustrative embodiments disclosed in the Figures; and Chatterjee et al., Lab Chip, 2009, 9, 1219-1229).

In typical embodiments of the invention described above, a dielectric layer(s) is disposed on the electrodes and optionally covers all of the electrodes. The dielectric layer(s) can comprise one or more dielectric materials commonly used in the art, such as parylene, positive photoresist, negative photoresist, materials with high dielectric constant, and/or materials with low dielectric constant. In some embodiments of the invention, a hydrophobic layer is disposed on the top surface of a dielectric layer and covers the whole dielectric layer. Additionally, for certain electrode plate embodiments, the dielectric layer and/or the hydrophobic layer can be optional in some areas of the device. Similarly, the dielectric layer may be treated or coated, in whole or in part, to make it more hydrophilic.

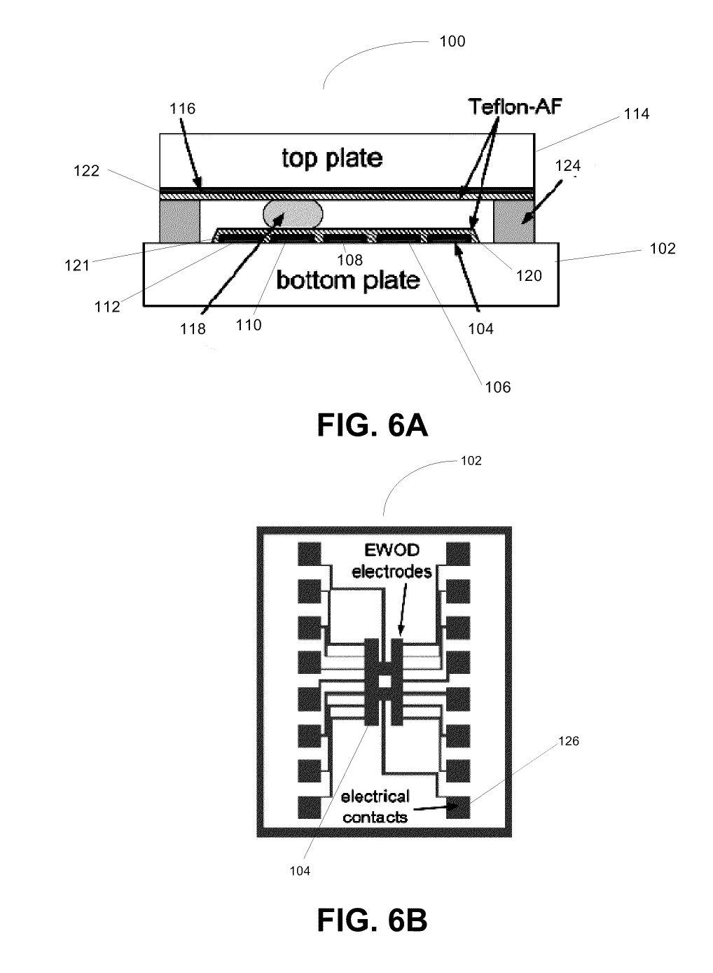

FIGS. 6A-6B illustrate a digital microfluidic device in accordance with the present invention. As shown in FIG. 6A, device 100 is formed each device was formed from a bottom plate 102 having individually addressable electrodes 104-112 and a top plate 114 with one contiguous electrode 116. Droplet 118 is shown between bottom plate 102 and top plate 114. Bottom plate 102 is formed from quartz wafers coated with a 3500-Å layer of phosphorus-doped polysilicon. Polysilicon electrodes 104-112 are patterned using standard photolithographic techniques and reactive ion etching. A typical formation of the electrodes 104-112 is to grow a thermal oxide (1500 A) on the polysilicon of bottom plate 102 in an oxidation furnace. Holes through the oxide to the electrical contacts were formed with photolithography and wet etching with buffered hydrofluoric acid. The devices were then primed with hexamethyldisilazane vapor and spin-coated (2000 rpm, 60 s) with 5% TEFLON-AF layer 120. The devices were postbaked on a hot plate (160° C., 10 min) and in a furnace (330° C., 30 min) to form a uniform 7500-Å layer 120 of TEFLON-AF. Layer 120 can be made from any polymer to achieve the desired surface hydrophobicity or hydrophilicity, or wettability. Additional layers 121 of dielectric or other material can be used to control the electron flow between electrodes 104-112 and any droplets that are placed on layer 120. The top plate 114 is a glass piece with the electrode 116 being formed from indium-tin oxide (ITO). A 150 Å layer 122 of TEFLON-AF was spin-coated (0.5%, processed as above) onto the ITO-coated top plate 114. Layer 122 can be made from any polymer to achieve the desired surface hydrophobicity or hydrophilicity, and does not have to be the same material as layer 120. The two plates 102 and 114 are joined with spacers 124 (at approximately 300 μm apart), which can be formed from three pieces of double-sided tape or other materials. Other spacings between plates 102 and 114 are possible within the scope of the present invention. FIG. 6B illustrates a top view of plate 102 in a typical digital microfluidics pattern, which comprises sixteen 1-mm2 electrodes 104-112 (having a typical 4-μm gap between electrodes) where each electrode 104-112 is connected to an electrical contact pad 126. Aqueous droplets 118 (0.5 μL) are sandwiched between the two plates 102 and 114 and are moved by applying ac potentials (1 kHz, 75 Vrms) between the electrode 116 in the top plate 114 and successive electrodes 104-112 in the bottom plate 102.

In typical embodiments of the invention, the first electrode plate and the second electrode plate are arranged in parallel. The spacers of the spacing structure are disposed between the first electrode plate and the second electrode plate, so that a space or gap is defined between the first electrode plate and the second electrode plate. Some embodiments of the invention include a gap-control device as a way to continuously vary the spacing between the plates. The gap can be varied continuously from about 10 μm to several mm. For descriptions of such gap control device embodiments, see Son et al., Lab Chip, 2009, 9, 2398-2401, the contents of which are incorporated by reference. Alternatively, one can use fabricated ridges or posts, or even gaskets or tape spacers to provide a gap of a fixed size. In typical embodiments of the invention, the electrodes can be activated manually (e.g. via contact pads connected to the liquid-actuating electrodes). In some embodiments of the invention, the microfluidic system can be mounted on a driving circuit board and electrically coupled with the driving circuit board by wires or connectors, so that the driving circuit board provides voltage to the electrode layer and the electrodes of the microfluidic system. Optionally, a controller (for example, a desktop computer, a notebook computer, a personal digital assistant or a mobile phone etc.) can be connected with the driving circuit board with or without wires. Users can then set various control programs in the controller, so that the controller can send a control signal to the driving circuit board according to the control programs and the driving circuit board can supply voltage for different electrodes according to the control signal. Further systems that are coupled to such computer components are discussed below.

In one methodological embodiment of using the microfluidic system, a user disposes (e.g. by pipetting, injecting or the like) a first fluid in the microfluidic system, that is, placing the fluid into a receiving space on one or a plurality of electrodes (e.g. in the reservoirs). The user can then dispose a second fluid in the same or a second a receiving space on one or a plurality of electrodes (e.g. in the reservoirs). In embodiments of the invention that use a fluid as a surrounding medium, one can then dispose a surrounding fluid medium into the space(s) to surround the fluid(s). Optionally, the fluid(s) and/or the surrounding fluid medium is disposed into the space(s) through an opening on the first or second electrode plates, for example an opening located over a reservoir. After a fluid is injected into the microfluidic system, the driving circuit board or the operator can apply a voltage. In a typical embodiment, the voltage is applied across electrode layer or a smaller electrode in the first (typically top) plate and one or more electrodes in the second (typically bottom) plate, to the electrode layer and one of the electrodes, so that the electric field between the electrode layer and the electrode changes, creating an electric field. That voltage may be DC or AC. The AC frequency is variable, and may be near-zero (e.g. 0.1 Hz), in the hundreds of kHZ range, or has high as 1 MHz. In some embodiments of the invention, a fluid droplet and a surrounding fluid medium is polarized in varying degrees, so that the pressure difference exists between the fluid and the surrounding fluid medium, and then the fluid flows in the low-pressure direction. Accordingly, as the driving circuit board applies voltage to different electrodes, the fluid(s) will flow towards the electrode to which the voltage is applied. Consequently, without a pump, the fluids can be controlled to flow towards different directions. In some embodiments of the invention, the configuration of the direction(s) of motion or sequence of droplet positions of the microfluidic system is typically unfixed, and is changeable with by applying voltages to different electrodes at different times. With this design, users can write control programs to control the driving circuit board to apply voltage to different electrodes, thereby controlling the manipulated fluid to flow towards different electrodes. Accordingly, programmable microfluid control can be achieved. The speed and direction a droplet is moved can be controlled by varying the sequence of electrodes that are addressed, the voltage and frequency applied at each electrode, the duration of the applied voltage, and the length of the pause between successive voltage applications. Several or many droplets can be moved and positioned independently and simultaneously by manual or programmed application of prescribed voltage sequences.

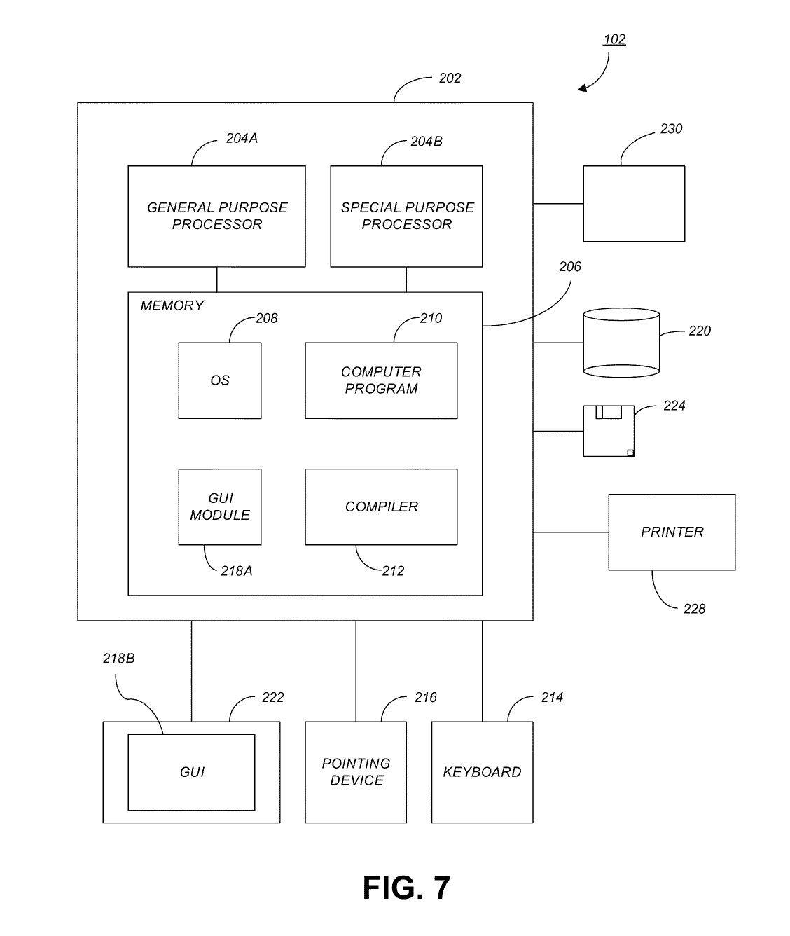

Embodiments of the invention can be coupled with a wide variety of hardware and software used with microfluidic devices designed to manipulate droplets of fluid (e.g. a power source coupled to a processor in order to apply a sequence of voltages to one or more electrode arrays). Illustrative elements useful in such context are disclosed, for example in the publications cited below as well as U.S. Patent Application Nos. 20090131543, 20090246279, 20090208548, 20060108224, 20060226012, 20080131613 and 20080169195, the contents of which are incorporated by reference. Embodiments of the invention disclosed herein can, for example, further be coupled with one of the many computer systems known in the art. FIG. 7 illustrates an exemplary generalized computer system 202 that can be used to implement elements the present invention, including the user computer 102, servers 112, 122, and 142 and the databases 114, 124, and 144. The computer 202 typically comprises a general purpose hardware processor 204A and/or a special purpose hardware processor 204B (hereinafter alternatively collectively referred to as processor 204) and a memory 206, such as random access memory (RAM). The computer 202 may be coupled to other devices, including input/output (I/O) devices such as a keyboard 214, a mouse device 216 and a printer 228.

In one embodiment, the computer 202 operates by the general purpose processor 204A performing instructions defined by the computer program 210 under control of an operating system 208, for example instructions relating to: (1) the application of a series of voltage pulses to an electrode array; (2) modulating the size of a gap between a first and second plate in a microfluidic device; (3) modulating an amount of fluid dispensed by a fluid conduit etc. The computer program 210 and/or the operating system 208 may be stored in the memory 206 and may interface with the user 132 and/or other devices to accept input and commands and, based on such input and commands and the instructions defined by the computer program 210 and operating system 208 to provide output and results. Output/results may be presented on the display 222 or provided to another device for presentation or further processing or action. In one embodiment, the display 222 comprises a liquid crystal display (LCD) having a plurality of separately addressable liquid crystals. Each liquid crystal of the display 222 changes to an opaque or translucent state to form a part of the image on the display in response to the data or information generated by the processor 204 from the application of the instructions of the computer program 210 and/or operating system 208 to the input and commands. The image may be provided through a graphical user interface (GUI) module 218A. Although the GUI module 218A is depicted as a separate module, the instructions performing the GUI functions can be resident or distributed in the operating system 208, the computer program 210, or implemented with special purpose memory and processors.

Some or all of the operations performed by the computer 202 according to the computer program 110 instructions may be implemented in a special purpose processor 204B. In this embodiment, the some or all of the computer program 210 instructions may be implemented via firmware instructions stored in a read only memory (ROM), a programmable read only memory (PROM) or flash memory in within the special purpose processor 204B or in memory 206. The special purpose processor 204B may also be hardwired through circuit design to perform some or all of the operations to implement the present invention. Further, the special purpose processor 204B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 202 may also implement a compiler 212 which allows an application program 210 written in a programming language such as COBOL, C++, FORTRAN, or other language to be translated into processor 204 readable code. After completion, the application or computer program 210 accesses and manipulates data accepted from I/O devices and stored in the memory 206 of the computer 202 using the relationships and logic that was generated using the compiler 212. The computer 202 also optionally comprises an external communication device such as a modem, satellite link, Ethernet card, or other device for accepting input from and providing output to other computers.

In one embodiment, instructions implementing the operating system 208, the computer program 210, and the compiler 212 are tangibly embodied in a computer-readable medium, e.g., data storage device 220, which could include one or more fixed or removable data storage devices, such as a zip drive, floppy disc drive 224, hard drive, CD-ROM drive, tape drive, etc. Further, the operating system 208 and the computer program 210 are comprised of computer program instructions which, when accessed, read and executed by the computer 202, causes the computer 202 to perform the steps necessary to implement and/or use the present invention or to load the program of instructions into a memory, thus creating a special purpose data structure causing the computer to operate as a specially programmed computer executing the method steps described herein. Computer program 210 and/or operating instructions may also be tangibly embodied in memory 206 and/or data communications devices 230, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 202. Although the term “user computer” is referred to herein, it is understood that a user computer 102 may include portable devices such as notebook computers, pocket computers, or any other device with suitable processing, communication, and input/output capability.

### Illustrative Methodological Embodiments of the Invention

The device systems discussed above can be used in a number of methods to form double emulsion droplets and polymer particles. An illustrative methodological embodiment of the invention comprises a method for forming a double emulsion droplet composition by combining a first liquid droplet and a second liquid droplet using a droplet-based microfluidic device capable of manipulating droplets. In this embodiment, the microfluidic device is used by placing the first liquid droplet on a first specified location on a surface of the droplet-based microfluidic device; and then placing the second liquid droplet on a second specified location on a surface of the droplet-based microfluidic device. In this method, one then moves at least one of the first or second droplets on the surface of the device so that the first and second droplets are brought into proximity such that the first liquid droplet spontaneously inserts into the second liquid droplet, thereby forming a double emulsion droplet. Alternatively, one moves at least one of the first or second droplets on the surface of the device so that the first and second droplets are brought into proximity such that the first liquid droplet spontaneously and completely engulfs the second liquid droplet, thereby forming a double emulsion droplet.

The term “spontaneously inserts” is used in accordance with its art accepted meaning and refers to a phenomena where a droplet inserts itself into another droplet without an external stimulus such as mechanically forcing one fluid into another. Without being bound by a specific theory of action, it appears that such insertions are the result of thermodynamic forces, where, for example, the thermodynamics of the two liquid in the environment in which they are disposed (e.g. in air on a hydrophobic surface) favor the formation of a double emulsion droplet over single discrete droplets. In this context, artisans understand that studies of the thermodynamic characteristics of the droplets (e.g. their surface tension) and surfaces (e.g. TEFLON, PDMS, poly(ethylene glycol) can be used to generate systems where spontaneous insertion is thermodynamically favored. Spontaneous insertion may occur without being facilitated or enabled by surface-active agents (surfactants), which have the property of lowering interfacial and surface tensions. As these events are spontaneous, they can be used in methods that have advantageous over forced or mechanical droplet in droplet insertions. For example, the devices disclosed herein eliminate the need for a number of specialized elements required for the mechanical insertion of a droplet within droplet, such as precise constellations of mechanical droplet insertion conduits.

The term “spontaneously engulfs” is used in accordance with its art accepted meaning and refers to a phenomena where a droplet completely surrounds or engulfs another droplet without an external stimulus such as mechanically forcing one fluid around another. Without being bound by a specific theory of action, it appears that such surrounding or engulfing processes are the result of thermodynamic forces, where, for example, the thermodynamics of the two liquid in the environment in which they are disposed (e.g. in air on a hydrophobic surface) favor the formation of a double emulsion droplet over single discrete droplets. In this context, artisans understand that studies of the thermodynamic characteristics of the droplets (e.g. their surface tension) can be used to generate systems where spontaneous engulfment is thermodynamically favored. As these events are spontaneous, they can be used in methods that have advantageous over forced or mechanical droplet in droplet engulfment. For example, the devices disclosed herein eliminate the need for a number of specialized elements required for the mechanical insertion of a droplet within droplet, such as precise constellations of mechanical droplet insertion conduits, or specialized elements for mechanically distributing one liquid around another so that the latter is completely coated or engulfed.

Double emulsion droplets and the products that can be made from them (e.g. polymer particles) can be adapted for use in a variety of industrial, research and pharmaceutical contexts. In some embodiments of the first liquid droplet and the second liquid droplet comprise a plurality of compounds that, when combined in the double emulsion droplet, can react to form a polymer particle. In such methods one can further expose the double emulsion droplet to reaction conditions sufficient to form the polymer particle. Optionally, the polymer particle forms a solid particle, a shell, or a core-shell particle. Those of skill in this art understand that particle embodiments of the invention include particles which are dense solids, porous, nanoparticulate, hydrogel, or even composites that contains particles or dissolved substances. In one illustrative embodiment, the polymer particle forms a highly spherical shell designed to contain a compound substances or substances such as deuterium and/or tritium, in gas, liquid or solid form.

In typical embodiments of the invention, a medium surrounding droplets as they move through the device is air. In other embodiments of the invention, a medium surrounding droplets as they move through the device is a droplet immiscible fluid. In some embodiments of the invention, first and second specified locations comprise a reservoir including an electrode that is operatively coupled to a plurality of electrodes configured to form a pathway along which droplets move on the surface of the droplet-based microfluidic device. Typically in such embodiments, a sequence of electrical signals is applied to a pattern of electrodes buried beneath a dielectric layer on the droplet-based microfluidic device surface to enable transport of droplets along the surface of the droplet-based microfluidic device.

Different microfluidic devices can be used in different embodiments of the invention. In some embodiments, the droplet-based microfluidic device comprises a single planar substrate having an array of electrodes disposed under a layer of a dielectric material. In other embodiments, the droplet-based microfluidic device comprises: a first planar substrate comprising a dielectric layer; a second planar substrate comprising a dielectric layer; wherein the first or second planar substrates are disposed in a parallel orientation and separated by a gap. This device further comprises a plurality of electrodes disposed under the dielectric layer on the first and second planar substrates, wherein the electrodes are disposed in a pattern that functions to generate an electromechanical force upon the sequential application of an electrical potential across the plurality of electrodes, wherein the electromechanical force is sufficient to move droplets along at least one pathway disposed in the gap between the first and second planar substrates.

Another embodiment of the invention is a method for forming a polymer particle, comprising: placing a first liquid droplet on a first specified location on a surface of a droplet-based microfluidic device, and then placing a second liquid droplet on a second specified location on a surface of the droplet-based microfluidic device. Placing means to position a droplet on a prescribed location on the device. This may be accomplished by dispensing a droplet from a reservoir on the device and moving it to a prescribe location, splitting or dividing an existing droplet and moving one or both to prescribed locations, or delivering liquid from an external source through an opening in one or the other plate or the side of the device and then moving it to a prescribed location. In such embodiments, the first and/or the second liquid droplet comprises at least one compound that reacts in a double emulsion droplet to form a polymeric material. The method then comprises moving at least one of the first or second droplets on the surface of the device so that the first and second droplets are brought into proximity such that the first liquid droplet spontaneously inserts into the second liquid droplet, thereby forming a double emulsion droplet; and allowing the compound in the double emulsion droplet to react and form a new material (e.g. by polymerization and/or gelation and/or crosslinking of a preformed polymer etc. etc.), for example so that a polymer particle is made. In an alternative embodiment, the first liquid droplet spontaneously surrounds or engulfs the second liquid droplet, thereby forming a double emulsion droplet; and allowing the compound in the double emulsion droplet to react and form a polymeric material, so that the polymer particle is made.

In such methods, the first and second liquids typically comprise at least one of a soluble component, a particulate component, a polymerizable monomer, a polymer (including a preformed polymer such as alginate which can be crosslinked), a cross-linking agent, or a gelation or polymerization initiator. For example, in certain illustrative embodiments of the invention, one can use a gelling agent (e.g. calcium ions) to induce gelation of a material (e.g. alginate). In embodiments using alginate, the alginate polymer can be pre-formed in a free flowing aqueous solution, and the addition of calcium induces gelation of this solution (e.g. to form a crosslinked polymeric hydrogel). Optionally such methods further comprise selecting a fluid for use in such methods based upon one or more material properties exhibited by the liquid. In some embodiments of the invention, the first liquid or the second liquid is selected for use in the method by determining a hydrophobic or a hydrophilic property of the first liquid or the second liquid. In other embodiments, the first liquid or the second liquid is selected for use in the method by determining one or more chemical or physical (e.g. thermodynamic) properties of the first liquid or the second liquid. Optionally, the first liquid or the second liquid is selected for use in the method by determining a surface tension property of the first liquid or the second liquid. In this context, typically the first liquid and the second liquid are of a predetermined volume. Using these selection parameters, a wide variety of polymeric particles can be made by embodiments of the invention. In some embodiments, the particles have diameters of a uniform defined size that is between 0.02 mm and 5.0 mm.

In the methods for forming polymer particles disclosed herein, the associated devices do not comprise channels adapted to contain and direct the flow of a fluid through the device. In illustrative embodiments, the droplet-based microfluidic device comprises a plate having an array of electrodes disposed under a layer of a dielectric material. These microfluidic devices comprise a second plate, comprising at least a second electrode, wherein the first plate and the second plate are spaced apart such that a droplet can travel between the first plate and the second plate. This device further comprises a first layer of a dielectric material, covering the array of first electrodes; and a second layer of a dielectric material, covering the at least second electrode, wherein application of electrical signals between selected electrodes within the array of first electrodes and the at least one second electrode moves the droplet between the top plate and the bottom plate. As discussed above, a number of additional materials can be used to facilitate embodiments of the invention. In certain embodiments for example, the microfluidic device further comprises an additional layer deposited on a dielectric layer, wherein the additional layer comprises a hydrophobic (e.g. TEFLON as discussed above to make the surface less wettable) or hydrophilic composition (e.g. poly(ethylene glycol) oligomers and polymers to make the surface more wettable).

As noted above, typical embodiments of the invention include a droplet microfluidic device and a process for using the device to synthesize doublet emulsion droplet compositions. In certain embodiments of the invention, the device is used to make porous and nonporous polymer particles having defined characteristics such as: (1) precisely controlled, pre-determined dimensions; and/or (2) particle diameters having a diameter from 0.02 mm to 5.0 mm; and/or (3) solid or hydrogel particles in various shapes, including spheres, oblate and prolate ellipsoids, and disks, and/or (4) solid or hydrogel shells in these same shapes, with interiors that may consist of air, a liquid, or a solid particle of a different material. The solid particle may consist of one or several substances, be homogeneous or heterogeneous in composition, may have glassy, foamy, fibrous or particulate morphology, and may incorporate solid particles of a different material, cells or microorganisms. The particles may consist of organic or inorganic materials or both. The particles can be made one at a time, sequentially, or in parallel (several or many simultaneously). In addition, the droplet compositions can be controlled to influence the characteristics of the desired product. For example, polymer particles can be prepared from solutions that contain pre-made polymer(s), polymerizable monomer(s), or both, as well as other agents that might be encapsulated or trapped.

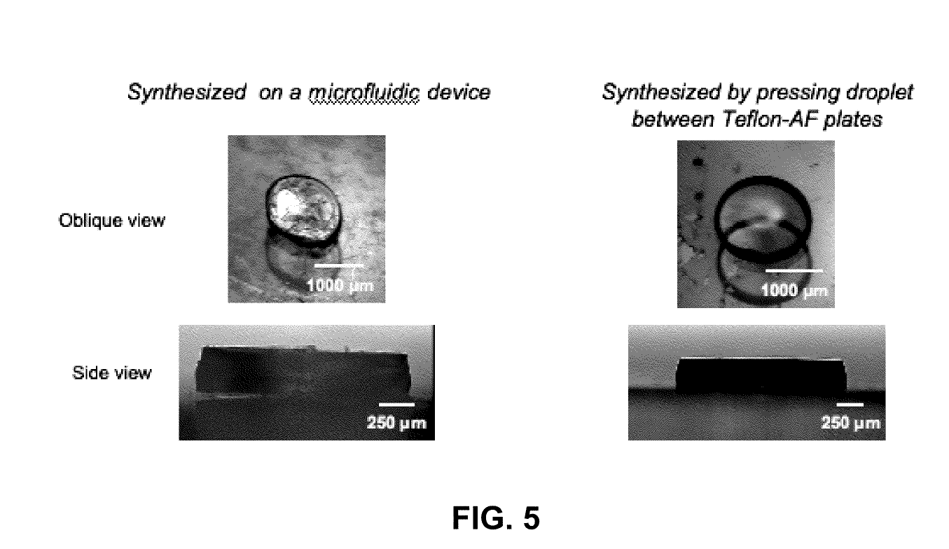

To illustrate embodiments of the invention, a digital microfluidic device was used to actuate a droplet containing monomer and initiator, causing it to insert into a stationary droplet of an immiscible liquid. Light was used to initiate polymerization, resulting in the formation of a solid, discoid particle (see, e.g. FIG. 5). We show that it is possible to maintain a spherical inner droplet, which can be polymerized to form a solid sphere, a shell or the like.

The ability to control particle size, shape and chemical composition is particularly important for the preparation of a variety of compositions including heterogeneous catalysts and drug delivery vehicles. There is significant interest in and need for new materials in these areas: for example, in the creation of degradable polymer shells for controlled drug release. In this context, embodiments of the invention offer unique capabilities for screening materials for drug delivery capsules. These include the ability to accurately dispense varying amounts of different polymerizable liquids on a single device, and at the same time vary parameters such as volumes, concentrations of various components, temperature, etc. Thus, diverse particles can be made simultaneously in one experiment, enabling rapid screening, testing and method optimization. For example, one might screen polymerization conditions, varying the ratio of two different monomers in one of the liquids in an emulsion droplet, to make hollow polymer particles that degrade at a specific rate for controlled drug release. In conjunction with screening polymer particle materials, encapsulation of drugs or catalyst inside polymer particles is easily accomplished using our innovation, and the entire process (liquid dispensing, emulsion formation, and polymerization) can be automated.

In some embodiments of the invention, a hardened shell may be formed around an inner droplet, such as by using a middle fluid that can be solidified or gelled. This can be accomplished with air or a liquid as the ambient medium. In this way, capsules can be formed with consistent inner droplets, as well as a consistent outer shell. Specifically, in such materials, the volumes (and hence the dimensions) can be controlled precisely and accurately so that the dimensions are highly reproducible. In some embodiments, this can be accomplished by a phase change in the middle fluid. A “phase change” fluid is a fluid that can change phases, e.g., from a liquid to a solid. A phase change can be initiated by a temperature change, for instance, and in some cases the phase change is reversible. For example, a wax or gel may be used as a middle fluid at a temperature which maintains the wax or gel as a fluid. Upon cooling, the wax or gel can form a solid or semisolid shell, e.g., resulting in a capsule. The shell may also be a bilayer, such as can be formed from two layers of surfactant.

According to still another set of embodiments, a specific shell material may be chosen to dissolve, rupture, or otherwise release its contents under certain conditions. For example, if a polymerosome contains a drug, the shell components may be chosen to dissolve or be otherwise degraded under certain physiological conditions (e.g., pH, temperature, osmotic strength), allowing the drug to be selectively released. Materials useful in these “smart capsules” are known to those skilled in the art. If it is desired that the inner species be dried, the shell material may be of a substance that is permeable to water molecules. Solid and core-shell polymer particles, as well as hollow polymer particles, are used in many applications in industry, consumer products and research. High-volume applications include pharmaceutical formulations, latex paints, lenses and heterogeneous catalysts.

Embodiments of the invention can use dielectrophoresis-based droplet centering technology to make polymer shells in which the outer and inner surface is highly concentric. One application for such shells is for use as cryogenic fuel targets for inertial confinement fusion energy production. Specifically, embodiments of the invention can be used to fabricate spherical hollow polymer particles that can be filled with deuterium/tritium ice. These cryogenic targets are used in inertial confinement fusion (ICF) technology, a promising new method for clean commercial energy production. Targets for ICF are hollow polymer shells that must meet extremely stringent size, shape and porosity requirements. The current method for making targets uses an established droplet generator technique based on multiphase flow technology. There are major drawbacks with this technology, however. First, disruptions of the liquid flows in the generator can create unwanted smaller droplets or variability in the droplet size; thus, the process must be carefully monitored and the shells must be sorted to select the good ones after drying. Second, sorting and characterization of the polymer targets is manpower intensive. Third, the apparatus has a large laboratory footprint. Fourth, the stripping fluid used to create the emulsion droplets in this process represents a large waste stream. Finally, the yield of foam shells that meet the wall thickness uniformity specification is very low. Embodiments of the invention can overcome these problems and limitations.

Embodiments of the invention exhibit a number of improvements over existing devices and methodologies. For example, in polymer chemistry, conventional bulk and batch methods for making polymer particles do not yield uniform size particles, especially when the desired diameters exceed 50 μm. Surfactants and/or emulsifying agents are needed to keep the dispersed droplets suspended in the surrounding liquid medium. These components may be undesirable and are difficult to remove completely. Moreover, conventional fluidic methods for synthesizing polymer particles of various sizes use hydraulic or electro osmotic pumps to continuously flow liquids through channels, tubes, or needles to form emulsion droplets prior to their polymerization. These continuous flow methods have several drawbacks. For example, disruptions of the liquid flow in these conventional devices can create unwanted smaller droplets or variability in droplet sizes. Consequently, the process must be carefully monitored during emulsion droplet formation in order to ensure that monodisperse polymer particles form. In addition, in such conventional methods, adjusting the particle size is typically accomplished manually and empirically. Conventional microfluidic devices cannot be easily reconfigured, and are limited to producing droplets within certain fairly narrow size ranges. The multiphase flow systems (e.g., utilizing co-flowing streams, cross-flowing streams, and flow-focusing) further generate considerable chemical waste (e.g. because a dispersing phase is required), waste that makes these conventional processes more expensive and environmentally unfriendly.

Embodiments of the invention overcome these drawbacks because, for example, the ambient medium can be air, the particle size can be controlled precisely and accurately etc. Experimental parameters used to define these characteristics include the dispensed volumes, which can range from sub-nL to nearly mL, the electrode dimensions, and the gap space in the device, which can range from just over 10 μm to several mm. In addition, droplet dispensing can be very precise. Volumes can be controlled to ±1% or better. This results in accurate, precise, deterministic control of the size of the particles that form. Moreover, a single device can be constructed to dispense droplets over a wide range of sizes and having diverse, prescribed shapes. In addition, the devices are readily controlled configurable software and/or programming, in order to allow, for example, the precise control over the rates of droplet generation, movement and insertion, as well as control over the sequence of droplet merging, mixing and reaction events. Similarly, particle production can be high throughput, using parallel paths on individual multiple devices. In addition, surfactants and/or dispersing liquids are not required, so the solvent waste stream is nonexistent. The ambient medium can be air or a liquid medium, but the latter is not a flow stream, so the volume required is minimal. Finally, the devices use very little power, as mechanical pumps and valves are not needed, and there is little resistance to droplet movement. This provides advantages over conventional channel based devices in which there are, for example, frictional losses at the channel walls when the liquid is moved.

Those of skill in this art understand that aspects of this technology can be adapted to form a wide variety of embodiments of the invention. All literature and other references are incorporated herein by reference. Literature describing methods, materials and devices that relate to embodiments of the invention includes U.S. Patent Application Nos. 20060108224, 20060226012, 20080131613 and 20080169195, Seo et al., Langmuir 2005, 21, (11), 4773-4775; Xu et al., Angewandte Chemie-International Edition 2005, 44, (25), 3799-3799; Nie et al., Journal of the American Chemical Society 2005, 127, (22), 8058-8063; Seo et al., Langmuir 2005, 21, (25), 11614-11622; Engl et al., Current Opinion in Colloid & Interface Science 2008, 13, (4), 206-216; Panizza et al., Colloids and Surfaces a-Physicochemical and Engineering Aspects 2008, 312, (1), 24-31; Engl et al., International Journal of Multiphase Flow 2007, 33, (8), 897-903; Carroll et al., Langmuir 2008, 24, (3), 658-661; Berkland et al., Journal of Controlled Release 2001, 73, (1), 59-74; Amsden et al., Pharmaceutical Research 1999, 16, (7), 1140-1143; Yang et al., Sensors and Actuators B-Chemical 2007, 124, (2), 510-516; Utada et al., MRS Bulletin 2007, 32, (9), 702-708; Chu et al., Angewandte Chemie-International Edition 2007, 46, (47), 8970-8974; Serra et al., Engineering & Technology 2008, 31, (8), 1099-1115; Shum et al., Journal of the American Chemical Society 2008, 130, (29), 9543-9549; Fan et al., Lab on a Chip 2009, 9, (9), 1236-1242; Lambert et al., Journal of Applied Polymer Science 1997, 65, (11), 2111-2122; Paguio et al., Journal of Applied Polymer Science 2006, 101, (4), 2523-2529; Tiarks et al., Langmuir 2001, 17, (3), 908-918; Chen et al., Journal of Vacuum Science & Technology a-Vacuum Surfaces and Films 1991, 9, (2), 340-344; Jo et al., European Polymer Journal 1996, 32, (8), 967-972; Huebner et al., Lab on a Chip 2008, 8, 1244-1254; Chiu et al., Accounts of Chemical Research 2009, 42, (5), 649-658; Shui et al., Advances in Colloid and Interface Science 2007, 133, 35-49; Koster et al., Lab on a Chip 2008, 8, 1110-1115; Christopher et al., J. Phys. D.: Appl. Phys. 2007, 40, R319-R336; Haeberle et al., Lab on a Chip 2007, 7, 1094-1110; Teh et al., Lab on a Chip 2008, 8, 198-220; Tan et al., In Springer Handbook of Nanotechnology, 2nd ed.; Bhushan, B., Ed. Springer: Berlin, 2007; pp 571-587; Chatterjee et al., Lab on a Chip 2006, 6, (2), 199-206; Moon et al., Lab Chip 2006, 6, 1213-1219; Wheeler et al., Analytical Chemistry 2005, 77, 534-540; Cho et al., Proceedings of the IEEE Conference on Microelectromechanical Systems 2003, 686-689; Cho et al., Journal of Microelectromechanical Systems 2003, 12, 70-80; Fan et al.,. Proceedings of the IEEE Conference on Microelectromechanical Systems 2003, 694-697; Fowler et al., Proceedings of the IEEE Conference on Microelectromechanical Systems 2002, 97-100; Jones et al., Langmuir 2003, 19, 7646-7651; Lee et al., Sensors & Actuators A 2002, 95, 259-268; Lok et al., Canadian Journal of Chemistry 1985, 63, 209; Chatterjee et al., Lab on a Chip 2009, 9, 1219-1229; Li et al., J. AM. CHEM. SOC. 2008, 130, 9935-9941; Seo et al., Langmuir 2005, 21, 11614-11622; Zhang et al., J. AM. CHEM. SOC. 2004, 126, 7908-7914; Zhang et al., J. AM. CHEM. SOC. 2006, 128, 12205-12210; Park et al., Annu. Rev. Mater. Res. 2010. 40:415-43; and Das et al., Annu. Rev. Mater. Res. 2006. 36:117-42.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended and the equivalents thereto.

1. A method for forming a double emulsion droplet composition, comprising:
combining a first liquid droplet and a second liquid droplet using a droplet-based microfluidic device capable of manipulating droplets, wherein the microfluidic device is used by:
placing the first liquid droplet on a first specified location on a surface of the droplet-based microfluidic device;
placing the second liquid droplet on a second specified location on a surface of the droplet-based microfluidic device; and
moving at least one of the first or second droplets on the surface of the device so that the first and second droplets are brought into proximity such that the first liquid droplet spontaneously inserts into the second liquid droplet or spontaneously engulfs the second liquid droplet, thereby forming a double emulsion droplet.

2. The method of claim 1, wherein the first liquid droplet and the second liquid droplet comprise a plurality of compounds that, when combined in the double emulsion droplet, can react to form a polymer particle.

3. The method of claim 2, further comprising exposing the double emulsion droplet to reaction conditions sufficient to form the polymer particle.

4. The method of claim 3 wherein the polymer particle forms a solid particle, a shell, or a core-shell particle.

5. The method of claim 1 wherein a medium surrounding droplets as they move through the device is air.

6. The method of claim 1, wherein the first and second specified locations comprise a reservoir including an electrode that is operatively coupled to a plurality of electrodes configured to form a pathway along which droplets move on the surface of the droplet-based microfluidic device.

7. The method of claim 1, wherein a sequence of electrical signals is applied to a pattern of electrodes buried beneath a dielectric layer on the droplet-based microfluidic device surface to enable transport of droplets along the surface of the droplet-based microfluidic device.

8. The method of claim 1, wherein the droplet-based microfluidic device comprises a single planar substrate having an array of electrodes disposed under a layer of a dielectric material.

9. The method of claim 1, wherein the droplet-based microfluidic device comprises:
a first planar substrate comprising a dielectric layer;
a second planar substrate comprising a dielectric layer;
wherein the first or second planar substrates are disposed in a parallel orientation and separated by a gap;
a plurality of electrodes disposed under the dielectric layer on the first and second planar substrates, wherein the electrodes are disposed in a pattern that functions to generate an electromechanical force upon the sequential application of an electrical potential across the plurality of electrodes, wherein the electromechanical force is sufficient to move droplets along at least one pathway disposed in the gap between the first and second planar substrates.

10. A method for forming a polymer particle, comprising:
placing a first liquid droplet on a first specified location on a surface of a droplet-based microfluidic device;
placing a second liquid droplet on a second specified location on a surface of the droplet-based microfluidic device;
wherein the first and/or the second liquid droplet comprises at least one compound that reacts in a double emulsion droplet to form a polymeric material;
moving at least one of the first or second droplets on the surface of the device so that the first and second droplets are brought into proximity such that the first liquid droplet spontaneously inserts into the second liquid droplet or spontaneously engulfs the second liquid droplet, thereby forming a double emulsion droplet; and
allowing the compound in the double emulsion droplet to react and form a polymeric material, so that the polymer particle is made.

11. The method of claim 10, wherein the first and second liquids comprise at least one of a soluble component, a particulate component, a polymerizable monomer, a cross-linking agent, or a polymerization initiator.

12. The method of claim 10, wherein the first liquid or the second liquid is selected for use in the method by determining a miscibility, a hydrophobic or a hydrophilic property of the first liquid or the second liquid.

13. The method of claim 10, wherein the first liquid or the second liquid is selected for use in the method by determining at least one thermodynamic property of the first liquid or the second liquid.

14. The method of claim 10, wherein the first liquid or the second liquid is selected for use in the method by determining a surface tension property of the first liquid or the second liquid.

15. The method of claim 10, wherein the first liquid and the second liquid are of a predetermined volume.

16. The method of claim 10, wherein the particles have diameters of a uniform defined size that is between 0.02 mm and 5.0 mm.

17. The method of claim 10, wherein the device does not comprise channels adapted to contain and direct the flow of a fluid through the device.

18. The method of claim 1, wherein the droplet-based microfluidic device comprises a plate having an array of electrodes disposed under a layer of a dielectric material.

19. The method of claim 10, wherein the microfluidic device comprises
a second plate, comprising at least a second electrode, wherein the first plate and the second plate are spaced apart such that a droplet can travel between the first plate and the second plate;
a first layer of a dielectric material, covering the array of first electrodes; and
a second layer of a dielectric material, covering the at least second electrode, wherein application of electrical signals between selected electrodes within the array of first electrodes and the at least one second electrode moves the droplet between the top plate and the bottom plate.

20. The microfluidic device of claim 19, further comprising an additional layer deposited on a dielectric layer, wherein the additional layer comprises a hydrophobic or a hydrophilic composition.
